(19) United States
(12) Patent Application Publication
(10) Pub. No.: US 2013/0048816 A1
(43) Pub. Date: Feb. 28, 2013

(54) Rackless Height Adjustable Mount For Attaching An Article To A Roof

(71) Applicants: Stuart H. Wentworth, Alamo, CA (US); Claudia H. Wentworth, Alamo, CA (US)

(72) Inventors: Stuart H. Wentworth, Alamo, CA (US); Claudia H. Wentworth, Alamo, CA (US)

(21) Appl. No.: 13/223,195

(22) Filed: Aug. 31, 2011

(51) Int. Cl. F16M 13/02

(52) U.S. Cl. 248/237

(57) ABSTRACT

The present application presents a height adjustable mount for attaching an article to a roof. This mount improves upon existing mounts by allowing a user to easily and repeatedly choose one of a plurality of discrete heights between a roof and the article to be mounted. The heights may be independently selected, thereby allowing adjustability to compensate for the uneven nature of many roofs.

### BACKGROUND

1. Field of the Invention

The present invention relates generally to attaching articles to the roof of a structure, and more particularly to a height adjustable mount for attaching articles to the roof of a structure.

2. Background of the Invention

There are many situations in which it is necessary or desirable to attach articles to the roof of a structure. These articles may be photovoltaic (a.k.a. solar) panels, photothermal panels, heating equipment, air conditioners, satellite dishes, and so on. Attachment is commonly accomplished by the use of one or more mounts which attach to the roof, and either provide mounting hardware for the article(s) or accept mounting hardware for the article(s). These mounts are usually designed so as to minimize leakage of water or other elements through the roof.

One issue encountered when mounting an article or articles on a roof is alignment. Most roofs or other structures are not truly flat or straight, whether by design or by imperfections, warping, or simple wear and tear. It is frequently desirable to attach articles to a roof such that they lay flat, and the unevenness common to roofs makes this challenging. Most mounts do not easily adjust the height between the article and the roof and thus do not solve this problem. Additionally, it may be desirable to mount articles at different heights even if the roof is flat or straight. Most mounts do not allow the article(s) to be mounted at various heights as may be advantageous for a specific installation of articles.

Another issue encountered when mounting an article or articles on a roof is the need to use a standard rack in addition to whatever mounts have been chosen for the particular installation. That is to say that usually when one installs articles on a roof the articles themselves must be installed in a rack/frame and this rack/frame is then attached to the roof via the mounts.

It is thus a first object of the present application to provide a height adjustable mount for attaching an article or articles to a roof structure.

It is a further object of the present application to provide a mount which provides a plurality of discrete heights between the roof and the article.

It is a further object of the present application to provide a mount which provides easy and repeatable selection of a specific height between the roof and the article.

It is a further object of the present application to provide a mount which includes built in cable guides.

It is a further object of the present application to provide a mount which does not require the use of a standard rack but instead employs the edge of the article as the structural element that is attached to the mount.

It is a further object of the present application to provide a mount that allows simple and easy height adjustment such that an installation of an article or articles may be quickly and easily adjusted/aligned for ascetics.

It is a final object of the present application to provide a mount for attaching an article or articles to a roof structure, which minimizes potential leakage through the roof.

These and other objectives, advantages, features, and aspects of the present invention will become apparent as the following description proceeds. To the accomplishment of the foregoing and related ends, the invention, then, comprises the features hereinafter more fully described and particularly pointed out in the claims, the following description and the annexed drawings setting forth in detail certain illustrative embodiments of the invention, these being indicative, however, of but several of the various ways in which the principles of the invention may be employed.

### SUMMARY OF THE INVENTION

The present application presents a height adjustable mount for attaching an article to a roof. This mount improves upon existing mounts by allowing a user to easily and repeatedly choose one of a plurality of discrete heights between a roof and the article to be mounted. The heights may be independently selected, thereby allowing adjustability to compensate for the uneven nature of many roofs.

### BRIEF DESCRIPTION OF THE DRAWINGS

The foregoing aspects and many of the attendant advantages of the invention will become more readily appreciated as the same becomes better understood by reference to the following detailed description, when taken in conjunction with the attached charts and figures, wherein:

FIG. 1 is a perspective view of a preferred embodiment of the mount;

FIG. 2 is a side view of a preferred embodiment of the mount;

FIG. 3 is a perspective view of the top portion of a preferred embodiment of the mount;

FIG. 4 is a side view of the top portion of a preferred embodiment of the mount;

FIG. 5 is a side view of the top portion of a preferred embodiment of the mount;

FIG. 6 is a perspective view of a preferred embodiment of the base of the mount;

FIG. 7 is a top view of a preferred embodiment of the base of the mount;

FIG. 8 is a side view of a preferred embodiment of the base of the mount along cut-line A-A of FIG. 7;

FIG. 9 is a series of side views of the mount;

FIG. 10 is a perspective view of an alternative embodiment of the base of the mount;

FIG. 11 is a top view of an alternative embodiment of the base of the mount;

FIG. 12 is a side view of an alternative embodiment of the base of the mount along cut-line A-A of FIG. 11;

FIG. 13 is a side view of a preferred embodiment of the mount including an embodiment of article attachment hardware;

FIG. 14 is a side view of a preferred embodiment of the mount including an embodiment of article attachment hardware;

FIG. 15 is an exploded side view of a preferred embodiment of the mount including an embodiment of article attachment hardware;

FIG. 16 is a perspective view of an alternative embodiment of the base;

FIG. 17 is a side view of the alternative embodiment of the base shown in FIG. 16;

FIG. 17b is a side view of the alternative embodiment of the base shown in FIG. 16;

wherein the alternative embodiment is attached to a post in partial view;

FIG. 17c is a side view of the alternative embodiment of the base shown in FIG. 16; wherein the alternative embodiment is attached to a post;

FIG. 18 is a perspective view of an alternative embodiment of the base;

FIG. 19 is a perspective view of an alternative embodiment of the base;

FIG. 20 is a perspective view of an alternative embodiment of the mount shown attached to a tile roof and holding an article;

FIG. 21 is a perspective view of a preferred embodiment of the mount shown attached to a shingled roof and holding an article;

FIG. 22 is a perspective view of a plurality of a preferred embodiment of the mount shown attached to a shingled roof and holding two articles;

FIG. 23 is a perspective view of an alternative embodiment of the mount;

FIG. 24 is a side view of an alternative embodiment of the mount;

FIG. 25 is a top view of an alternative embodiment of the mount;

FIG. 26 is a perspective view of an alternative embodiment of the mount which includes an integrated cable guide;

FIG. 27 is a top view of an alternative embodiment of the mount which includes an integrated cable guide;

FIG. 28 is a side view of an alternative embodiment of the mount which includes an integrated cable guide;

FIG. 29 is a side view of an alternative embodiment of the mount which includes an integrated cable guide;

FIG. 30 is a perspective view of an alternative embodiment of the mount;

FIG. 31 is a perspective view of an alternative embodiment of the base;

FIG. 32 is a top view of the alternative embodiment of the base first shown in FIG. 31;

FIG. 33 is a side view of the alternative embodiment of the base first shown in FIG. 31;

FIG. 34 is a side view of the alternative embodiment of the base first shown in FIG. 31;

FIG. 35 is a side view of an alternative embodiment of the base;

FIG. 36 is a perspective side view of the alternative embodiment of the base first shown in FIG. 35;

FIG. 37 is a side view of the alternative embodiment of the base first shown in FIG. 35; and

FIG. 38 is a perspective view of the alternative embodiment of the base first shown in FIG. 35.

### DETAILED DESCRIPTION OF THE INVENTION

The following description is presented to enable a person of ordinary skill in the art to make and use various aspects and examples of the present invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded the scope consistent with the appended claims.

The present application presents a height adjustable mount for attaching an article to a roof. This mount allows a user to easily and repeatedly choose one of a plurality of discrete heights between a roof and the article mounted thereto.

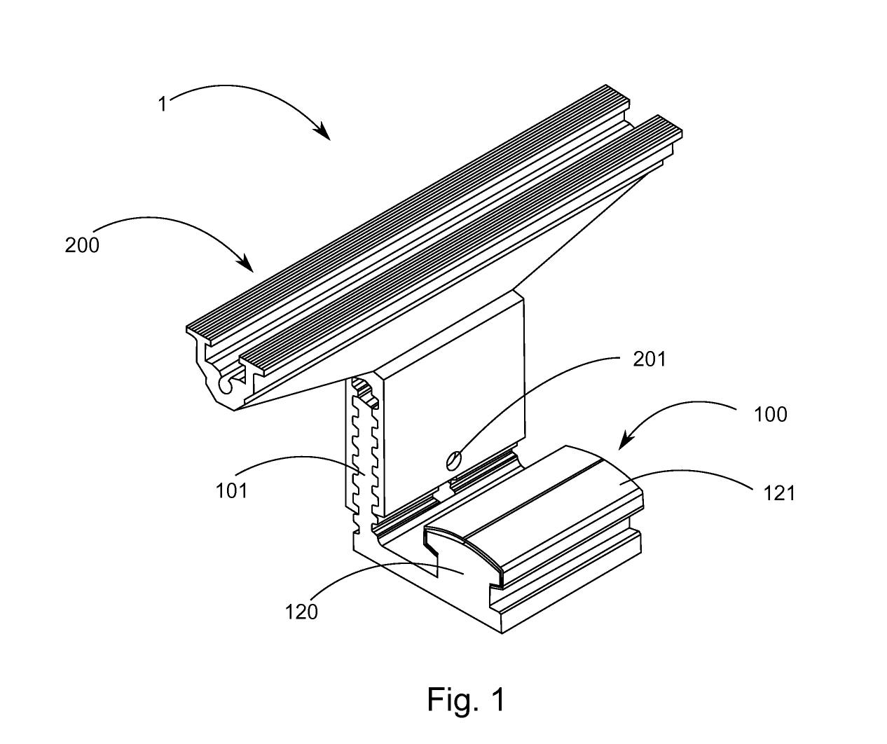

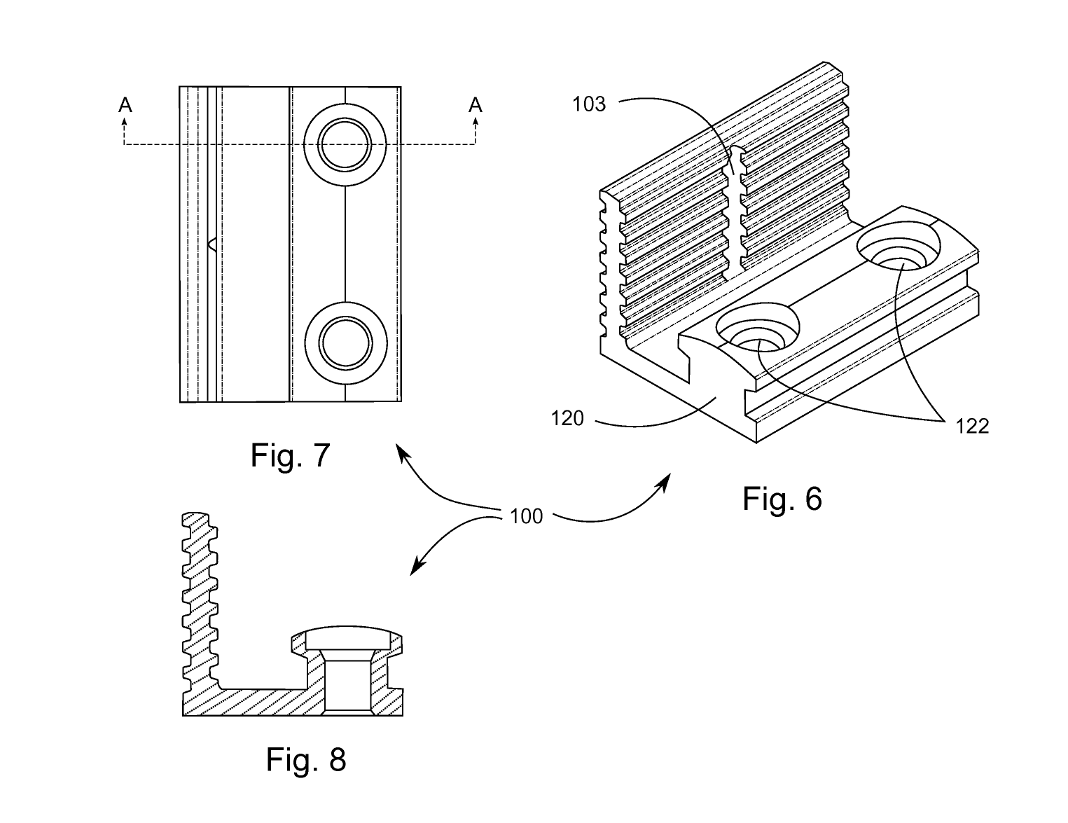

Turning first to FIG. 1, a perspective view of a preferred embodiment is shown. The preferred embodiment mount 1 comprises a base 100 and a top portion 200, which interlock at a plurality of discrete heights. In a preferred embodiment the top portion 200 is between six and eleven inches long, however, in alternative embodiments the top portion may longer than eleven inches or shorter than six inches. As will be clear from the following figures and description, the top portion slides over the base via interlocking components, preferably protrusions and/or recesses. After the top portion has been slidingly interlocked with the base as shown in FIG. 1, the top portion may be secured in place by use of a bolt (not shown) placed through bolt hole 201. In a preferred embodiment bolt hole 201 is a clearance hole on one side and a ¼×20 tap on the other. In alternative embodiments the bolt hole may be clearance on both sides, or may take any suitable form known in the art which will accept a bolt or other fastening member. The upstanding member 101 of the base has a corresponding blot slot 103 (see briefly, FIG. 6) to allow the bolt to secure the base and the top portion together. In an alternative embodiment a wire guide may also be attached to the mount via the bolt and bolt hole, such an embodiment is shown in FIGS. 26-29. For the purposes of this application, the upstanding member is generally planer in shape and in a preferred embodiment projects substantially vertically from the base, substantially vertically meaning for the purposes of this application with fifteen degrees of vertical. In alternative embodiments the upstanding member need not project substantially vertically, but may instead project at other angles. For the purposes of this application generally planer is taken to mean that the object in question is substantially longer and/or wider than it is thick.

Returning to FIG. 1, in most embodiments, base 100 comprises an attachment portion 120. In a preferred embodiment the attachment is a roof attachment portion 120 as shown, and which is configured to attach to a roof with one or more fasteners. In other embodiments the attachment may be accomplished by other structures. Also shown in FIG. 1 is cover 121, which in a preferred embodiment slides over the roof attachment portion 120 of the base 100. In other embodiments, the cover may take any form known in the art such as but not limited to plugs. In yet other embodiment no cover is present at all. In the preferred embodiment the base attached to a roof with a flashing 600 (not shown in FIG. 1).

In a preferred embodiment the base and the top portion are made of a metal, and more particularly aluminum. In other embodiments the base and top portion may be made of any suitable material known in the art including but not limited to metal, plastic, ceramic, and composite. The base and top may be made of different materials.

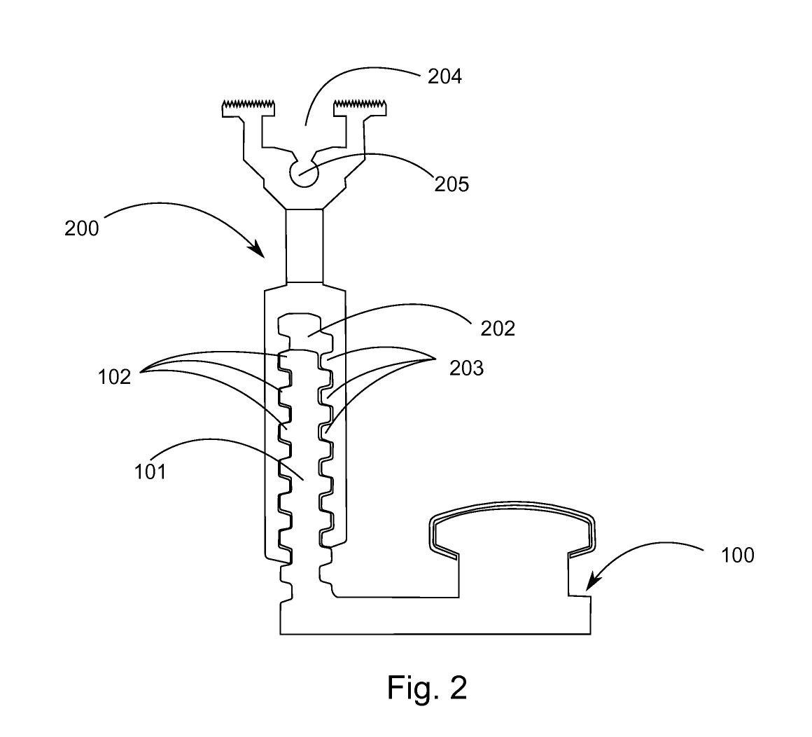

Turning now to FIG. 2, a side view of a preferred embodiment is shown. As may be seen clearly in this view, the upstanding portion 101 comprises a plurality of height adjustment protrusions 102 and/or height adjustment recesses (not labeled). In a preferred embodiment these height adjustment protrusions and/or recesses are of a regular ridge and recess form as shown in FIG. 2. In alternative embodiments the height adjustment protrusions/recesses may take any form known in the art, provided it allows the base and top portion to interlock at one of a plurality of heights.

In a preferred embodiment, the top portion comprises a vertical channel 202, each side of which comprises height adjustment protrusions and/or recesses 203 configured to interlock with the height adjustment protrusions and/or recesses 102 of the upstanding member 101 at a plurality of discrete positions achieving varying heights between the base and the top portion, and thereby varying heights between the roof and the article. It is noted, and will be further illustrated below, that the top portion may interlock in two orientations with the base. In other words the upstanding member 101 can flip-flop and attach either direction. Note that the upstanding member may be thought of as a base height adjustable interlocking means.

It is important to note that in the preferred embodiment the recesses may be conceptualized as the space between the protrusions. In an alternative embodiment the protrusions may be thought of as the portions of material between the recesses. The terminology is effectively interchangeable, but one terminology may be preferable over the other depending upon the manufacturing process employed to create the base and top portion.

In a preferred embodiment, in order to allow the top portion to slide and interlock with the upstanding member in either of two orientations the height adjustment protrusions/recesses disposed on the upstanding member are configured such that each protrusion on one side of the upstanding member is vertically aligned with a recess on the opposite side of the upstanding member, and visa-versa.

At the upper end of top potion 200 is a receiver track 204 for receiving an inverted bolt and thereby the article attachment hardware. In a preferred embodiment the receiver track 204 is sized to receive a 5/16 inch inverted bolt, however, it should be readily understood that the receiver track may be sized to receive a different size bolt, or may be replaced entirely with any structure known in the art and which is capable of receiving article attachment hardware, or of directly mounting an article. Also at the upper end of top portion 200 is a screw race 205 configured to accept accessories such as but not limited to a ground clip or a cap.

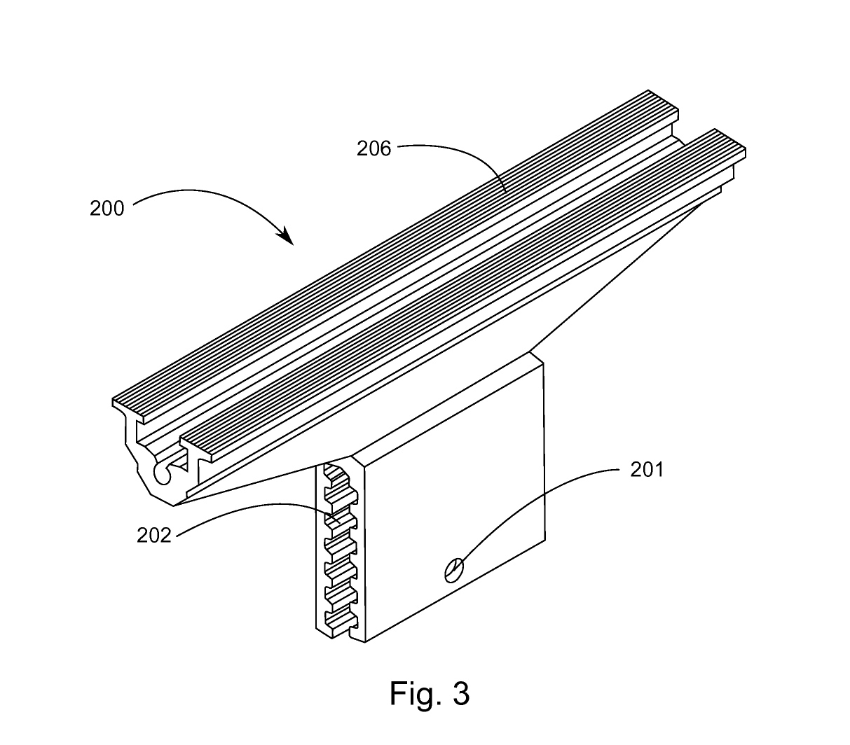

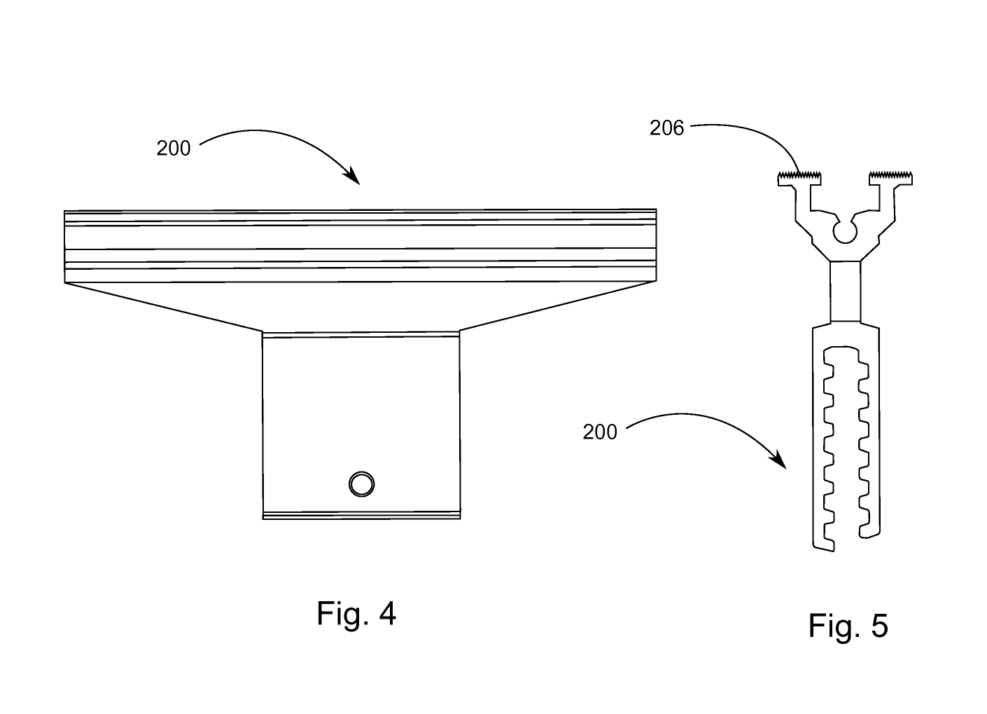

Turning to FIGS. 3, 4, and 5, a perspective view, and two side views of the top portion 200 of a preferred embodiment is shown. In this preferred embodiment the upper end of top portion 200 comprises friction ridges 206 running longitudinally on top of the receiver track 204 shown best in FIG. 2. These friction ridges 206 aid in securing an article to the top portion. In alternative embodiments these friction ridges may take any form known in the art such as ridges running perpendicular to those shown in the FIG. 3, surface texture, or may be omitted entirely.

Turning to FIGS. 6, 7, and 8, a perspective view, and two side views of the base of a preferred embodiment is shown. It is noted that FIG. 8 shows a side view along cut line A-A in FIG. 7. The base comprises bolt slot 103, which corresponds to bolt hole 201 in the top portion. As may be seen the bolt slot 103 extends vertically through most of the upstanding member 101 and allows the top portion and the base to be secured together at one of a plurality of heights after the top portion is slid over and interlocked with the upstanding member at one of a plurality of discrete positions. In this preferred embodiment the attachment portion 120 comprises two roof attachment holes 122, which in this preferred embodiment are dimensioned to be coupled with a flashing (not shown) and to then accept one screw driven into the roof (one screw per hole). These screws anchor the base to the roof, and the flashing ensures that water doesn't leak through the roof. After the base is anchored to the roof, the cover 121 (see FIG. 1) is slid over the attachment portion 120 to further prevent water from leaking through the roof. In alternative embodiments there may be only a single roof attachment hole 122, or the roof attachment holes may be replaced with any structure known in the art which would serve to anchor the base to the roof. Similarly, the screws may be replaced with any fastener known in the art such as but not limited to bolts.

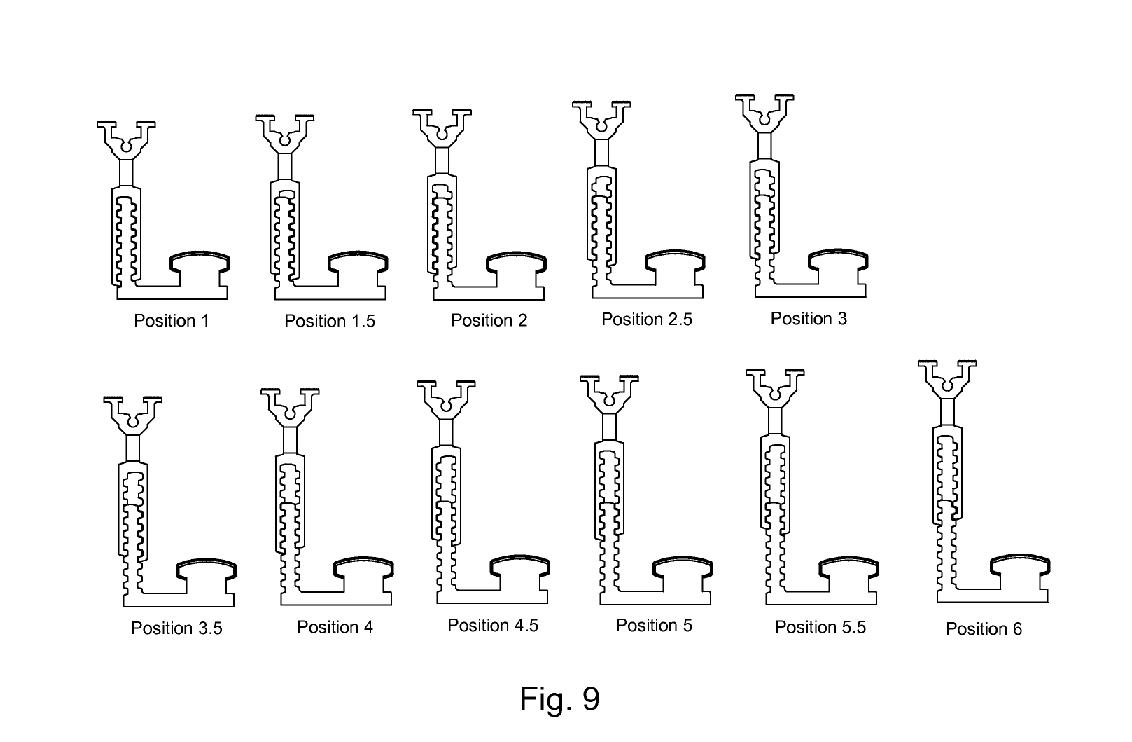

Turning to FIG. 9, a series of side views of the mount are shown. These side views illustrate how the top portion 200 and the base 100 (not labeled in this Fig.) may be slid together and interlocked at a plurality of discrete heights. Note that the top portion may be slid together and interlocked with the base in one of two orientations, and each of the two orientations allows for different discrete heights to be achieved. In all embodiments the top portion and the base may be slid together and interlocked at a minimum height, at a maximum height, and at a plurality of discrete heights between the minimum and maximum height. In all embodiments the maximum height is less than twice the minimum height. In all embodiments the maximum height is technically achieved when the top portion is interlocking with one of the upstanding member's protrusions, however, due to stability concerns the preferred minimum number of upstanding member protrusions interlocked is 3, as shown in Position 6.0.

Another way to conceptualize the various heights between the roof and the top of the receiving track sets a minimum height as H=1 unit height. The mount may then be configured at any of a plurality of discrete heights Hₙ where 1≦Hₙ<2. Here, and in practice, the number of discrete configurations has no upper limit.

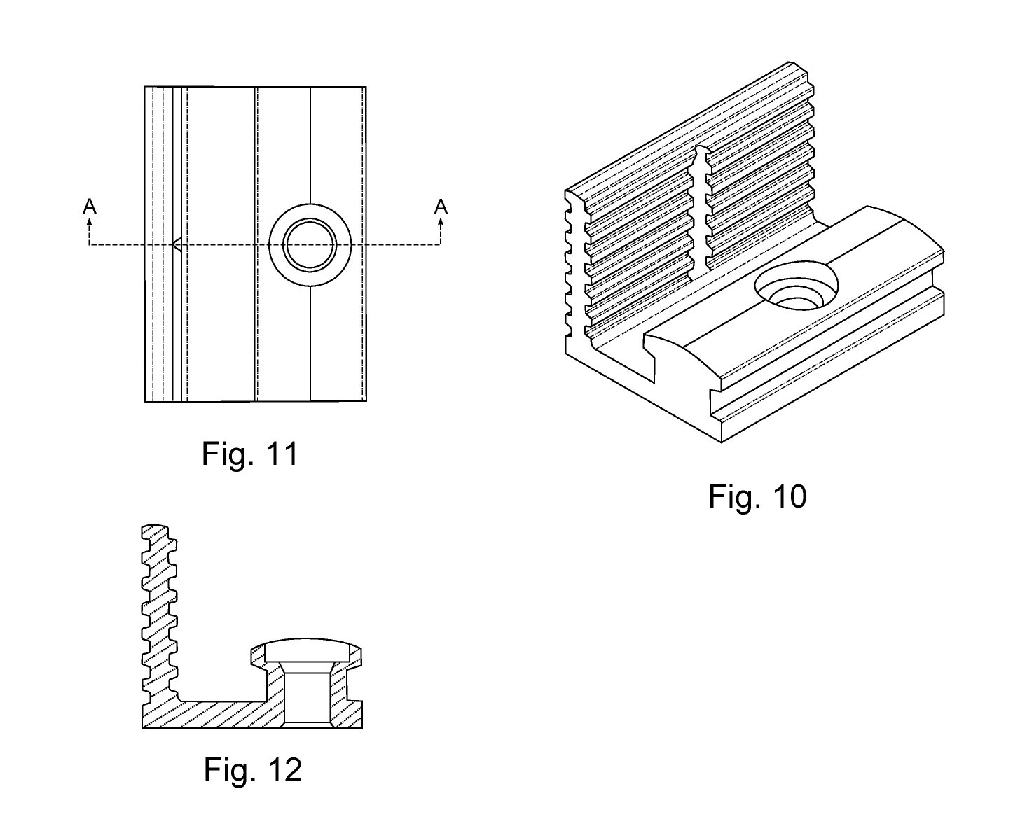

Turning to FIGS. 10, 11, and 12, a perspective view, and two side views of the base of an alternative embodiment is shown. Note that FIG. 12 shows a side view along cut-line A-A of FIG. 11. As may be seen, this alternative embodiment of the base differs in that it includes a single roof attachment hole.

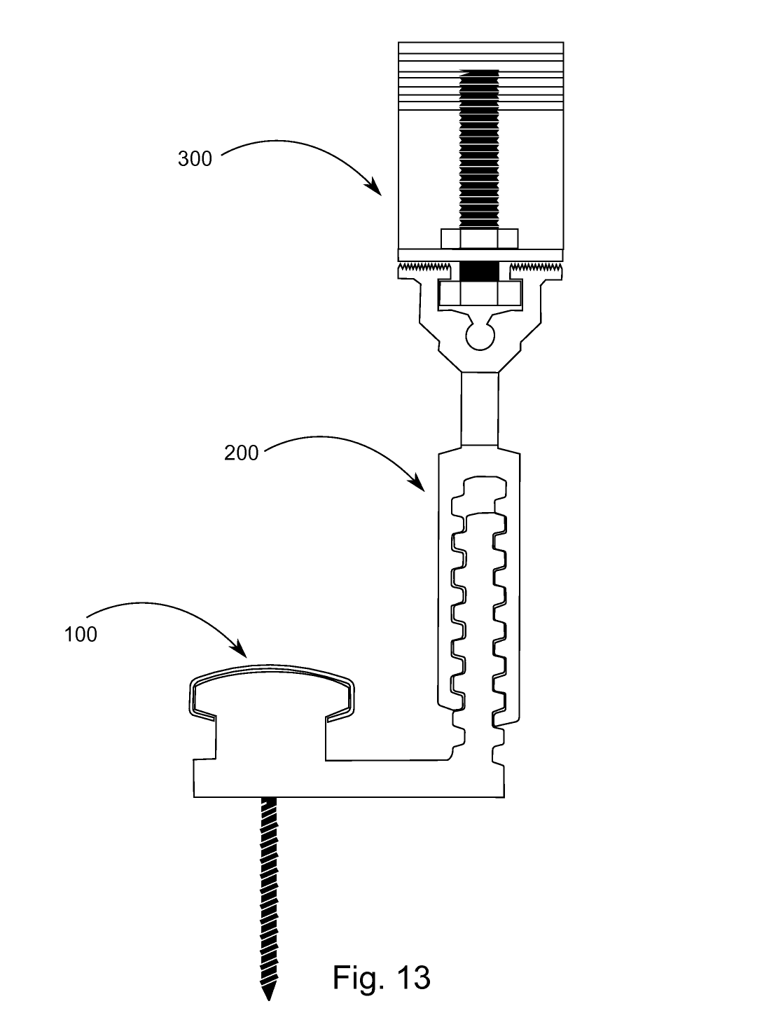

Turning to FIG. 13, a side view of a preferred embodiment of the base 100, top section 200, and a first embodiment of article attachment hardware 300 is shown. As may be seen an inverted bolt (not labeled) has been slid into receiver track 204 (not labeled), and article attachment hardware 300 has been secured to the bolt and the top section by a nut.

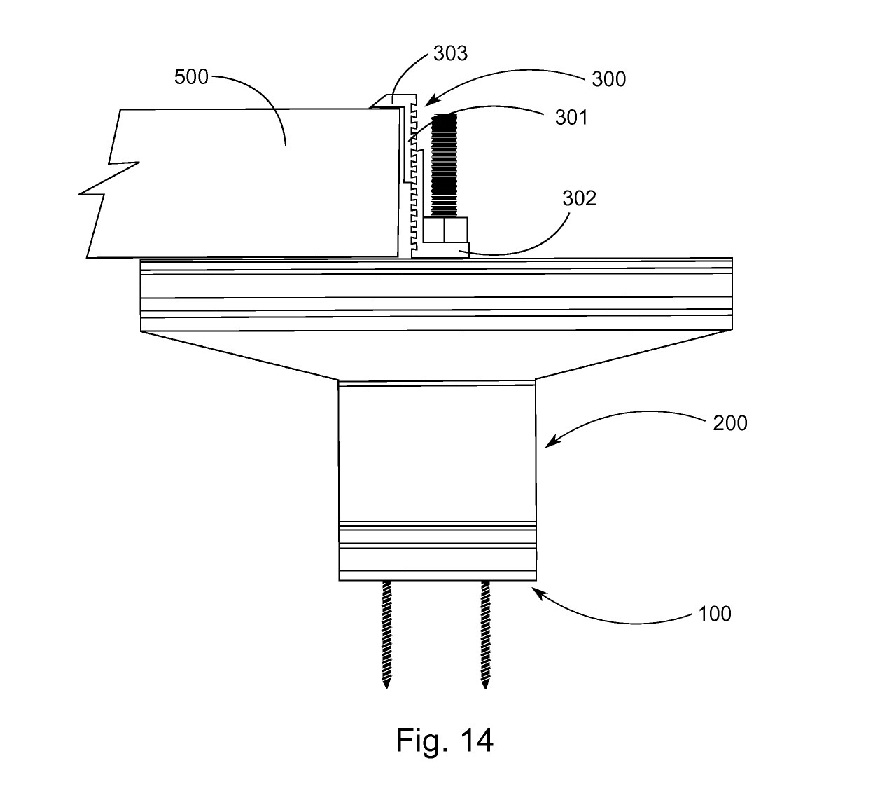

Turning to FIG. 14, a side view of a preferred embodiment of the base 100, top section 200, and a first embodiment of article attachment hardware 300 is shown. Article attachment hardware comprises a lower section 302 and an upper section 301. Lower section is secured to the top portion 200 by the bolt passing through lower section 301 and a nut on the bolt. Lower section and upper section interlock at one a plurality of discrete heights by use of periodic protuberances/recesses disposed on a surface of the lower section and corresponding periodic protuberances/recesses disposed on a surface of the upper section configured to interlock with those on the lower section. These protuberances/recesses may take any form known in the art such as but not limited to a comb, dovetail design, or more creative jigsaw puzzle-type shapes. The lower and upper sections 302 and 301 may attach to each other by any other means known in the art such as but not limited to fasteners and adhesives. In alternative embodiments the upper and lower sections 302 and 301 may be replaced with a single piece article attachment hardware.

In this first embodiment article attachment hardware 300 comprises a clamping portion 303 configured to overlay and exert pressure towards the top portion 200 on an article 500. The pressure exerted by the clamping portion 303 on the article 500 is sufficient to securely hold the article to the top portion 200, and thereby attach the article to the mount, and thereby to the roof. This first embodiment of article attachment hardware is suitable to attach a top portion to a single article.

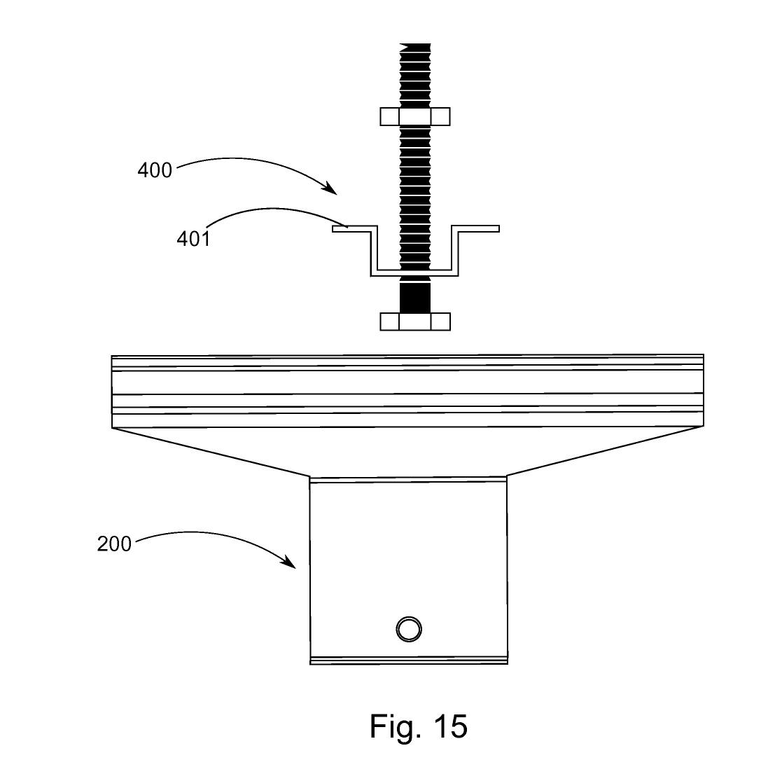

Turning to FIG. 15, an exploded side view of a preferred embodiment of the base 100, top section 200, and a second embodiment of article attachment hardware 400 is shown. In this embodiment the article attachment hardware 400 comprises a securing piece 401, which has a hole to slide onto the bolt, and is then secured with a nut. Fully assembled, the bolt will be slid into the receiving track as shown in FIGS. 13-14, and the nut will be tightened urging the securing piece 401 towards the top portion 200. This embodiment of article attachment hardware is suitable for attaching a top portion to two articles. Each side of the securing piece 401 will exert pressure on an article and thereby secure it to the top portion, and thereby to the mount and roof.

It is to be appreciated that the first and second embodiments of article attachment hardware are but two of many possible embodiments, and that the articles may be secured to the top portion by any means known in the art such as but not limited to directly bolting the articles to the top portion.

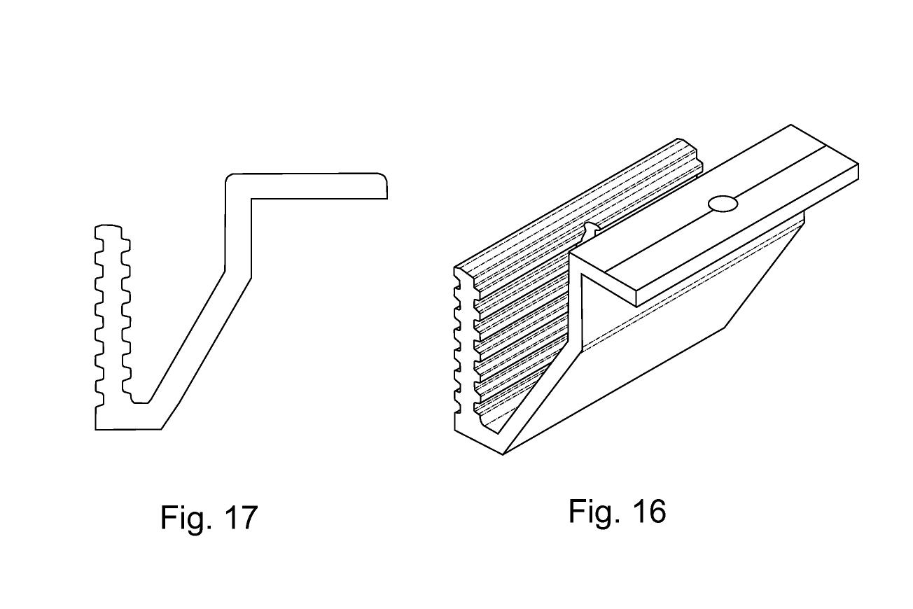

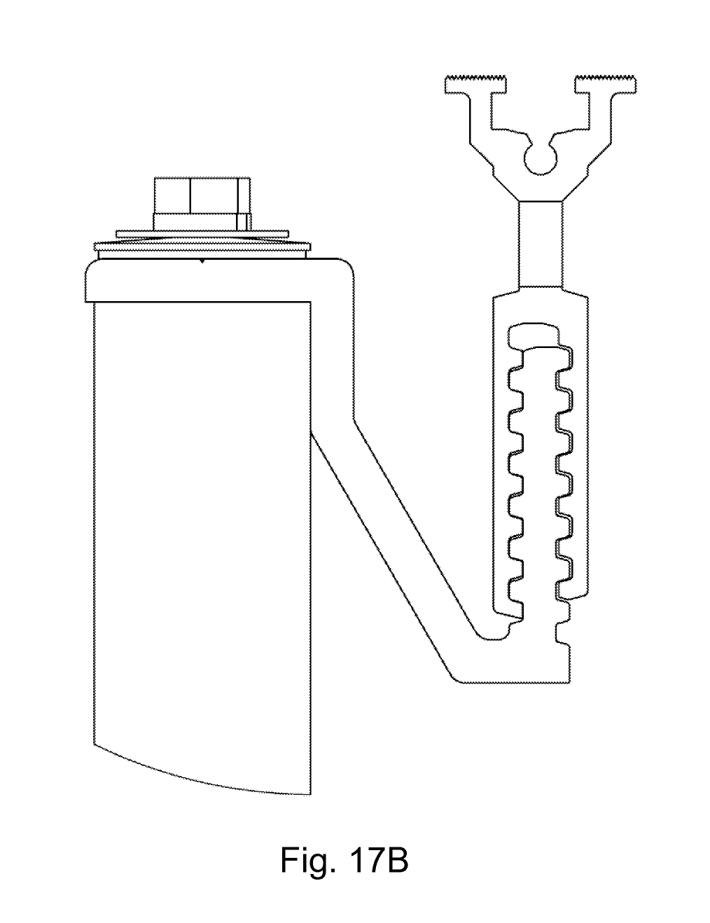

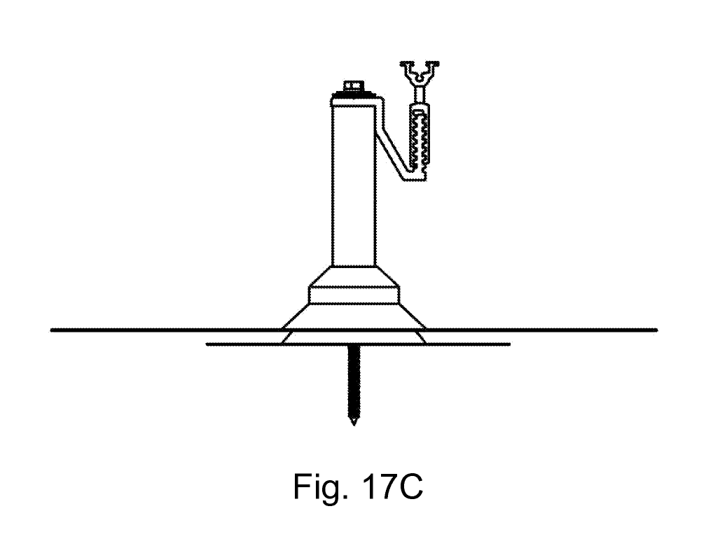

Turning to FIGS. 16 and 17, a side view and a perspective view of an alternative embodiment of the base is shown. This embodiment allows the base to be mounted onto the top of a post while adding little height to the overall mounting system. FIGS. 17b and 17c expand on this embodiment by showing depicting said attachment to a post (not labeled).

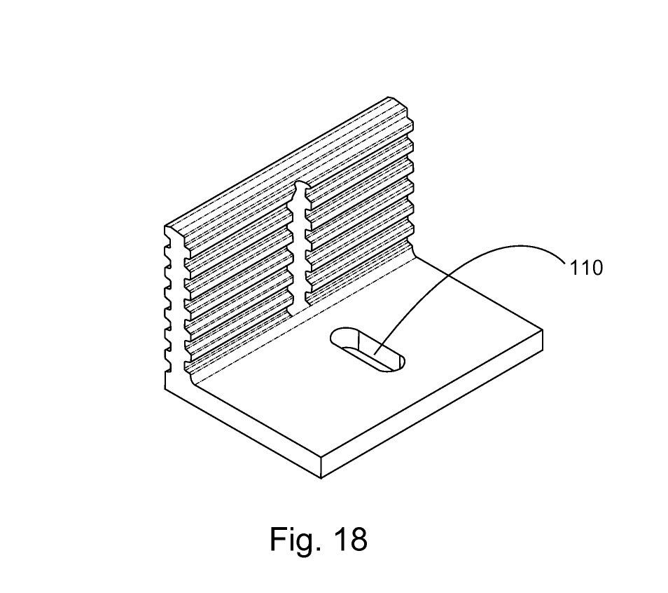

Turning to FIG. 18, a perspective view of an alternative embodiment of the base 100 is shown. In this embodiment the roof attachment portion has been removed and instead the base includes a simple bolt slot through which any appropriate fastener (such as but not limited to screws and bolts) may be driven to attach the base to a roof.

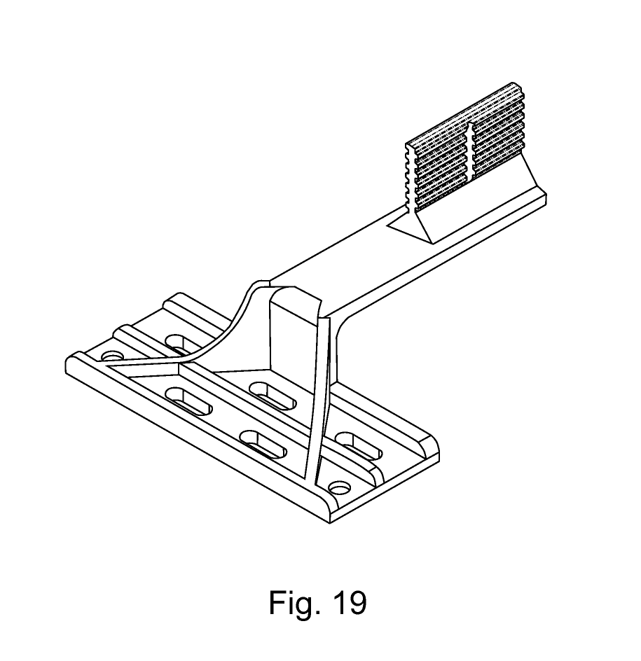

Turning to FIG. 19, a perspective view of an alternative embodiment of the base is shown. In this embodiment the upstanding member has been incorporated onto a roof mounting hook which is commonly used worldwide. The upstanding member may be attached to nearly any standard mount or hook to allow for height adjustable mounting of an article(s).

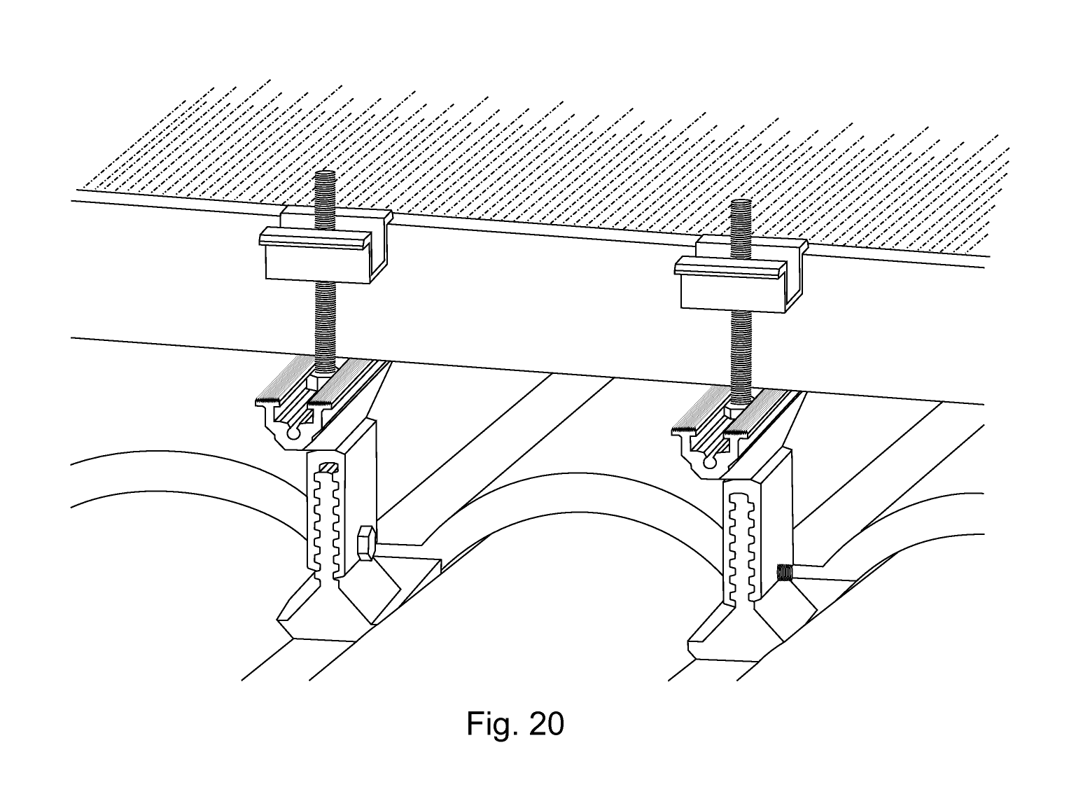

Turning to FIG. 20, a perspective view of an alternative embodiment of the mount is shown attached to a tile roof and holding an article. In this embodiment the upstanding member is attached to a base configured to slide up and under a roof tile. As may be seen in this figure, each base/top portion pair has been slid together and interlocked at a different height so as to account for roof unevenness. Note that while only single article is shown for clarity, the article attachment hardware as shown is configured to hold two articles, one as shown, and one extending towards the bottom of the figure.

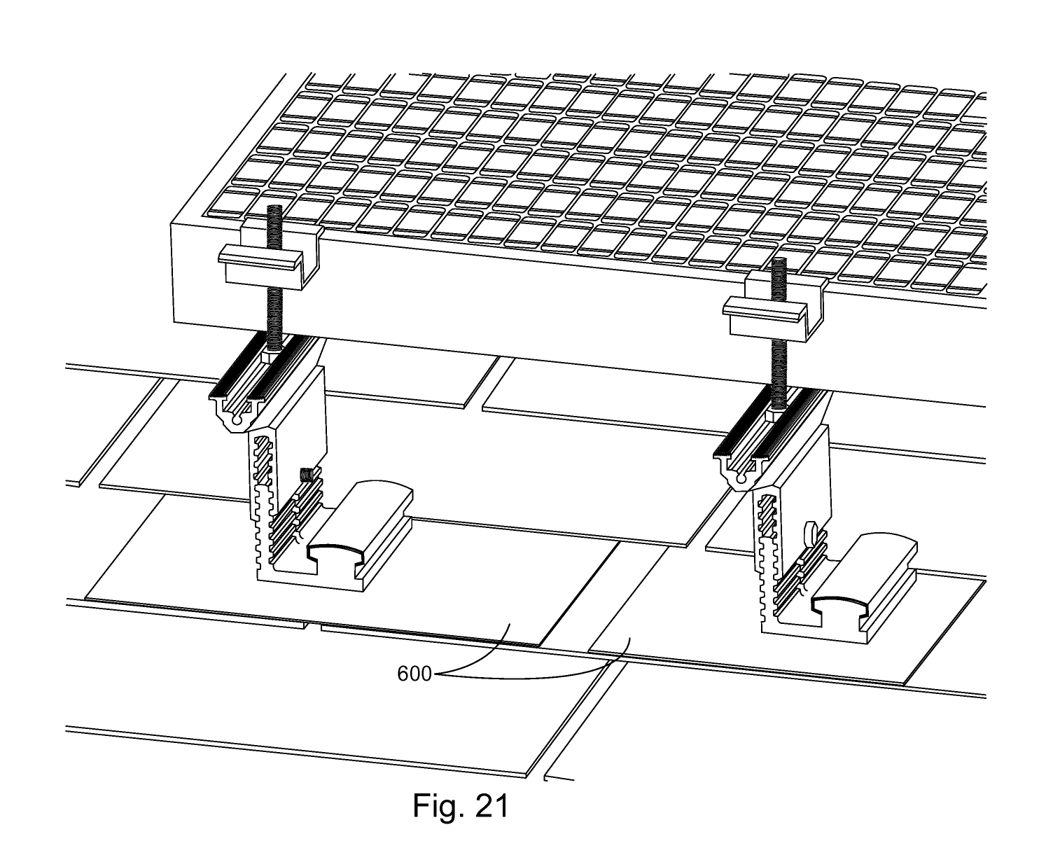

Turning to FIG. 21, a perspective view of a preferred embodiment of the mount is shown attached to a shingled roof and holding an article. In this embodiment each base is attached to the roof with a flashing 600 intermediate the base and the roof. The flashing slides up and under the shingles on the roof and prevents leakage of water through the roof. As may be seen in this figure, each base/top portion pair has been slid together and interlocked at a different height so as to account for roof unevenness. Note that while only a single article is shown for clarity, the article attachment hardware as shown is configured to hold two articles, one as shown, and one extending towards the bottom of the figure.

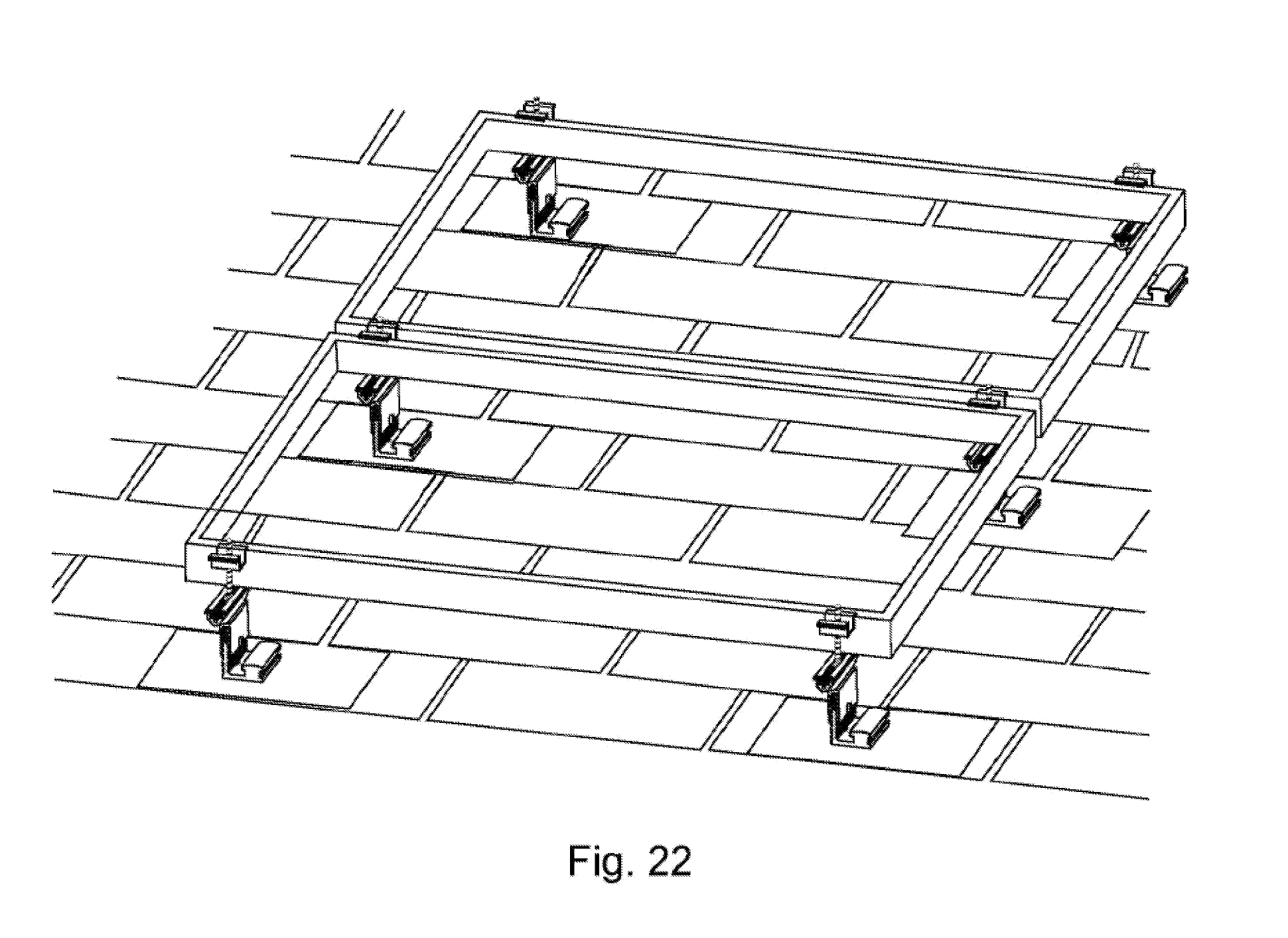

Turning to FIG. 22, a perspective view of a plurality of a preferred embodiment of the mount is shown attached to a shingled roof and holding two articles. In this embodiment each base is attached to the roof with a flashing 600 intermediate the base and the roof. The flashing slides up and under the shingles on the roof and prevents leakage of water through the roof.

One feature of the mount which is shown clearly in FIGS. 20-22 is that the article(s), in this case solar panels, are attached directly to the mount and do not require a standard rack. The mount simply attaches directly to the edge of the article(s), and that edge acts as the structural member. This feature of the mount saves time and money when installing an article or articles on a roof as a standard rack need not be purchased or installed.

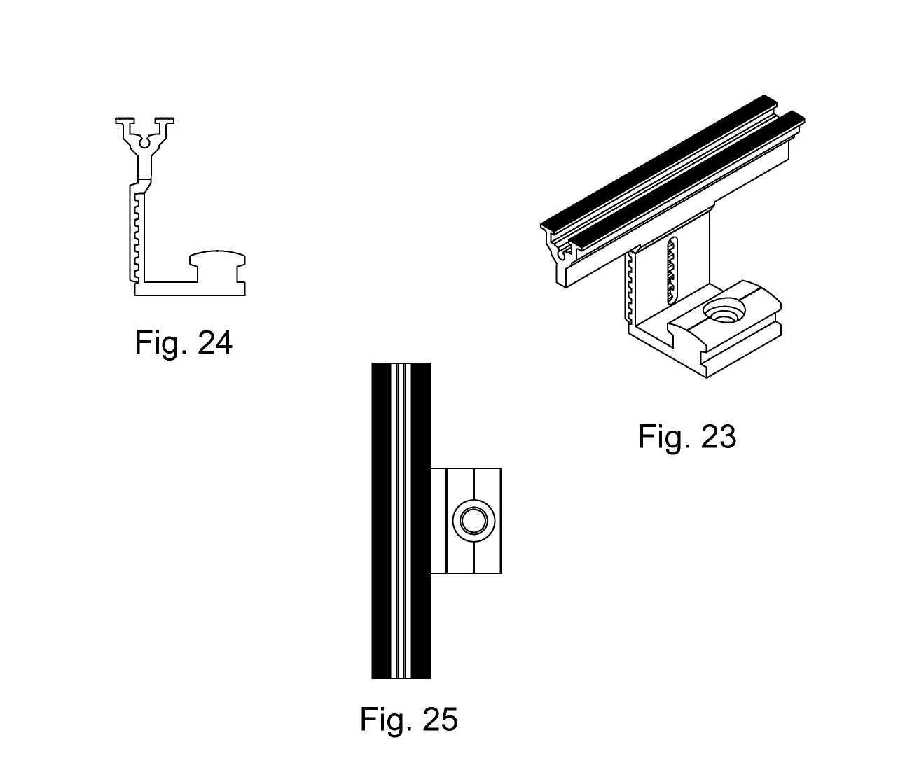

Turning to FIGS. 23-25, a perspective view, a top view, and a side view of an alternative embodiment of the mount is shown. This embodiment differs from the above-disclosed embodiments in that the upstanding member has height adjustment protrusions and/or height adjustment recesses on only a single side of the upstanding member. This embodiment also differs from the above-disclosed embodiments in that the top portion comprises a single vertical surface configured to slide and interlock with the upstanding portion of the base. This single surface comprises height adjustment protrusions and/or height adjustment recesses configured to interlock with those on the upstanding portion of the base. The top portion also comprises a bolt hole as disclosed above to secure the top portion to the base after they have been interlocked.

Turning to FIGS. 26-29, a perspective view, a top view, and two side views of an additional alternative embodiment of the mount is shown. This embodiment differs from the above disclosed embodiments in that the mount further comprises a wire guide attached to the base via the bolt and bolt hole. The wire guide may comprise a conduit, channel, or other suitable structure for securing and organizing wires.

Turning to FIG. 30 a perspective view of an alternative embodiment of the mount is shown. This embodiment differs from the above-disclosed embodiments in that the two roof attachment holes have been reoriented such that the mount would attach to the rafter of a roof 90 degrees offset from the above-disclosed embodiments. This may be desirable depending upon the design of the roof the mount and the article(s) are being attached to.

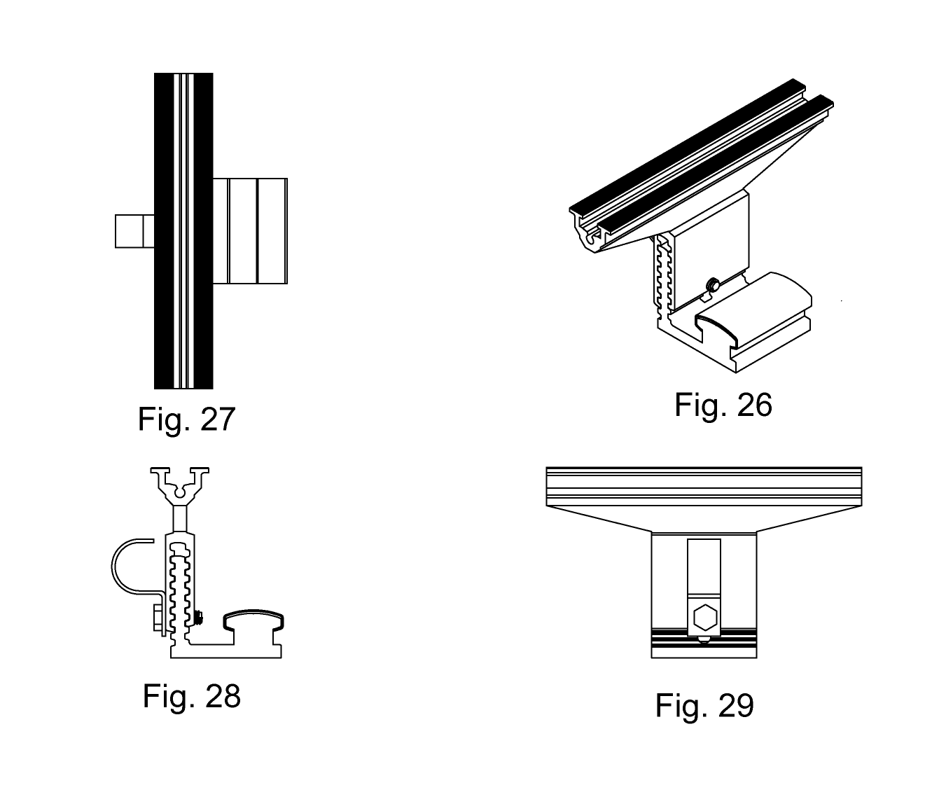

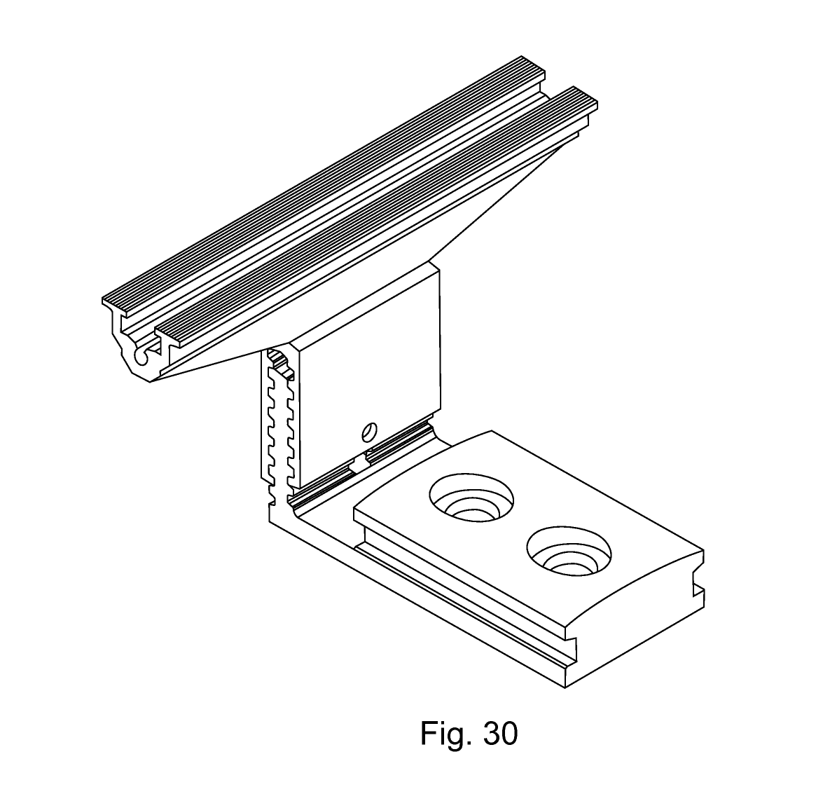

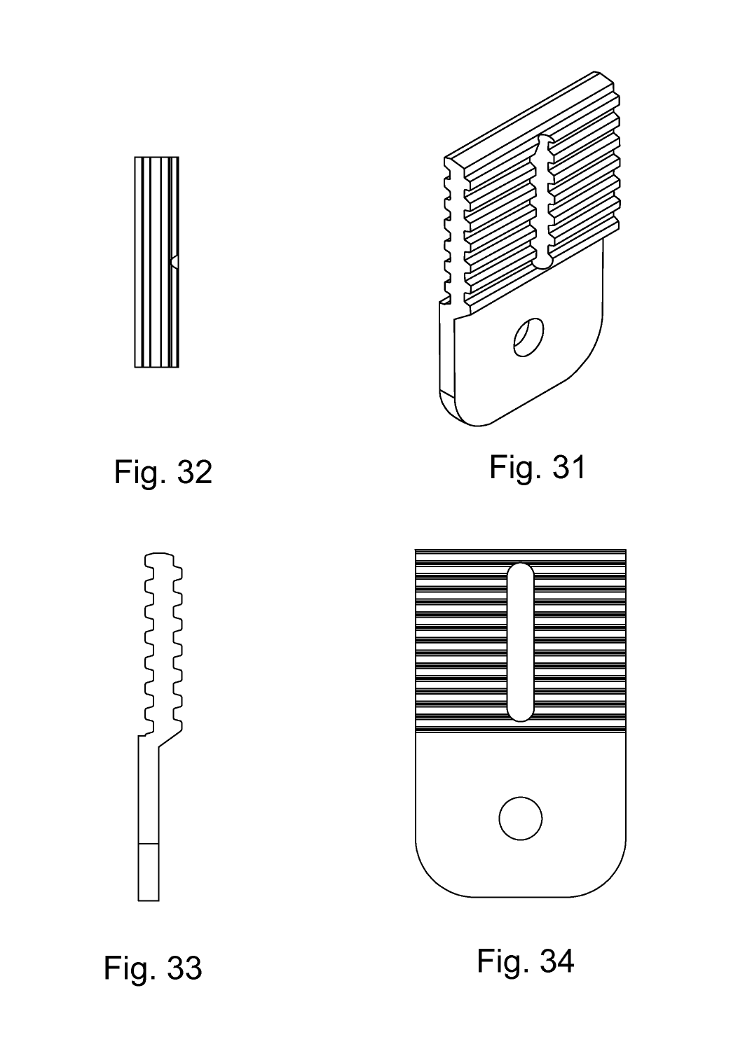

Turning to FIGS. 31-34, a perspective view, a top view, and two side views of an alternative embodiment of the base is shown. This embodiment differs from the above-disclosed embodiments in that the roof attachment holes configured to accept screws driven into a roof have been removed and replaced with a single attachment hole configured to accept a screw driven into the side of a structure. This base could be used for example if it was advantageous to attach the base to the edge of a roof.

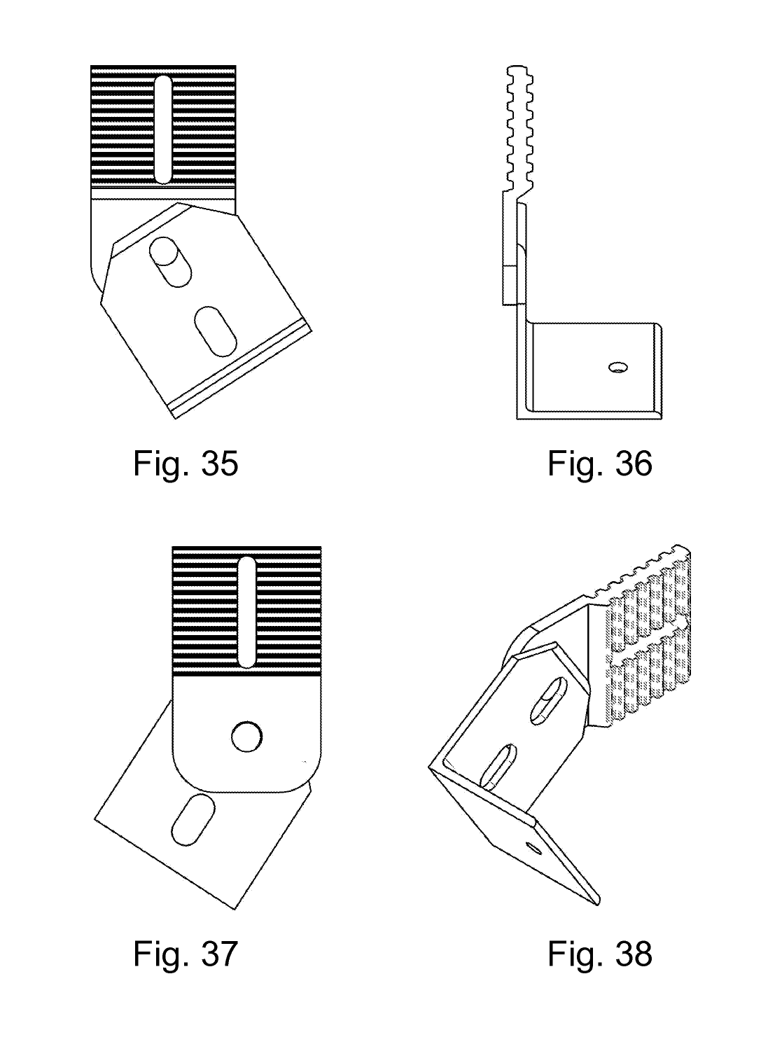

Another embodiment similar to the embodiment shown above is depicted in FIGS. 35-38. In this embodiment the base is replaced with an alternative base that allows for tilting adjustments to be made to the upstanding portion.

Although the invention has been shown and described with respect to certain embodiments, it is obvious that equivalent alterations and modifications will occur to others skilled in the art upon the reading and understanding of the specification. In particular, with regard to the various functions performed by the above-described components, the terms (including any reference to a “means”) used to describe such components are intended to correspond, unless otherwise indicated, to any component which performs the specified function of the described component (e.g., that is functionally equivalent) even though not structurally equivalent to the disclosed component which performs the functions in the herein exemplary embodiments of the invention. In addition, while a particular feature of the invention may have been disclosed with respect to only one embodiment, such feature may be combined with one or more other features of other embodiments as may be desired or advantageous for any given or particular application.

We claim:

1. An apparatus for mounting an article on a roof comprising:
a. a base comprising an upstanding member further comprising:
i. a front side and a back side;
ii. a plurality of at least three adjacent height adjustment protrusions; and
iii. height adjustment recesses between said protrusions;
b. a top portion configured to interlock with the upstanding member; and
c. wherein the base is configured to attach to a roof of a structure.

2. The apparatus of claim 1 wherein:
a. said top portion comprises a channel configured to slide over at least a portion of the upstanding member and interlock with at least three of said height adjustment protrusions.

3. The apparatus of claim 2 wherein:
a. the top portion is configured to interlock with the upstanding member in a first and second orientation;
b. the first orientation allowing a first set of discrete heights;
c. the second orientation allowing a second set of discrete heights;
d. wherein each second set discrete height being between two adjacent first set discrete heights; and
e. the first orientation being 180 degrees offset from the second orientation.

4. The apparatus of claim 2 wherein:
a. each height adjustment protrusion on the front side is vertically aligned with a corresponding recess on the back side; and
b. each height adjustment recess on the front side is vertically aligned with a corresponding protrusion on the back side.

5. The apparatus of claim 2 wherein:
a. the top portion is configured to interlock with the upstanding member in a first and second orientation, wherein said first orientation provides a first set of discrete heights and said second orientation provides a second set of discrete heights.

6. The apparatus of claim 2 wherein:
a. said top portion is configured to interlock with the upstanding member at a plurality of discrete heights.

7. The apparatus of claim 6 wherein:
a. the plurality of discrete heights comprises a minimum height and a maximum height less than twice the minimum height.

8. The apparatus of claim 7 wherein:
a. the top portion is configured to attach directly to at least one article.

9. The apparatus of claim 8 further comprising:
a. a wire guide.

10. The apparatus of claim 1 wherein:
a. said height adjustment protrusions and height adjustment recesses are disposed on both said front side and said back side.

11. The apparatus of claim 1 wherein:
a. the plurality of at least three of height adjustment protrusions are disposed on one of said front side and the back side.

12. The apparatus of claim 11 wherein:
a. said top portion comprises a surface configured to interlock with the height adjustment protrusions.

13. The apparatus of claim 12 wherein:
a. the top portion is configured to interlock with the upstanding member at a plurality of discrete heights.

14. The apparatus of claim 12 wherein:
a. the surface comprises a plurality of interlocking recesses configured to interlock with said height adjustment protrusions.

15. The apparatus of 14 wherein:
a. the vertical surface is configured to interlock with the upstanding member at a plurality of discrete heights.

16. The apparatus of claim 1 wherein:
a. the top portion is configured to attach directly to at least one article.

17. The apparatus of claim 1 further comprising:
a. a wire guide.

18. An apparatus for mounting an article on a roof comprising:
a. a base comprising a base height adjustable interlocking means and a roof attachment means; and
b. a top portion configured to accept an article mounting means and comprising a top portion height adjustable interlocking means configured to interlock with the base portion height adjustable interlocking means at a plurality of heights.

19. An apparatus for mounting an article on a roof comprising:
a. a base comprising a base height adjustable interlocking means and at least one of a post attachment means and a side attachment means; and
b. a top portion configured to accept an apparatus mounting means and comprising a top portion height adjustable interlocking means configured to interlock with the base portion height adjustable interlocking means at a plurality of heights.
